(19) United States
(12) Patent Application Publication
(10) Pub. No.: US 2007/0266152 A1
(43) Pub. Date: Nov. 15, 2007

(54) Computer peripheral device with computer security control mechanism

(76) Inventor: Jian-Cheng Chen, San Chong (TW)

Correspondence Address: Raymond Sun, 12420 Woodhall Way, Tustin, CA, 92782, US

(21) Appl. No.: 11/410,762

(22) Filed: Apr. 25, 2006

(51) Int. Cl. G06F 15/173

(52) U.S. Cl. 709/225

(57) ABSTRACT

A method for controlling access to a computer first provides a peripheral device with an identification number, and which is coupled to a computer. Next, the accuracy of the identification number of the coupled peripheral device is verified. Operation of the computer is prevented if the identification number is not correct. On the other hand, if the identification number is correct, a first predetermined time for operation of the computer is counted, and then operation of the computer is prevented after the first predetermined time has elapsed.

### BACKGROUND OF THE INVENTION

1. Field of the Invention

The present invention relates to a computer peripheral device, and in particular, to a peripheral device having a computer security control mechanism that controls the operation of a computer system.

2. Description of the Prior Art

Normally, a computer system user usually uses BIOS (basic input/out system) control as a primary security measure for blocking any unwelcome user from accessing the computer system. However, it is easy for a malicious attacker to decode passwords or codes to gain access to personal information through networks, or the like.

As a result, so-called biometric security devices have been designed to address this security concern. Examples of such biometric security devices include finger print identification devices, among others. Unfortunately, these security devices can be expensive and inconvenient to use.

In addition, some parents have desired to limit the use of a computer by their children. As a result, a plug-in device or an installed software is provided that will limit the child's use of the computer to a predetermined or pre-set amount of time. These plug-in devices and software will typically require the user to input an identification number to gain access to the computer. Unfortunately, similar problems will be encountered again due to the potential leakage of the access code, which is often based on the date of birth, ID number or the like.

### SUMMARY OF THE DISCLOSURE

It is an object of the present invention to provide a computer peripheral device having a computer security control function.

It is another object of the present invention to provide a computer peripheral device that has a time control function.

In order to accomplish the objects of the present invention, there is provided a method for controlling access to a computer. According to this method, a peripheral device is provided with an identification number, and is coupled to a computer. Next, the accuracy of the identification number of the coupled peripheral device is verified. Operation of the computer is prevented if the identification number is not correct. On the other hand, if the identification number is correct, a first predetermined time for operation of the computer is counted, and then operation of the computer is prevented after the first predetermined time has elapsed.

The present invention also provides a system that includes a computer peripheral device and a computer. The peripheral device has a computer security mechanism that includes an identification number. The computer is coupled to the peripheral device and includes a detecting module, a control module, and an execution module. The detecting module verifies the accuracy of the identification number, and the control module enables the execution module to end the operation of the computer when the identification number is not acceptable to the computer.

### BRIEF DESCRIPTION OF THE DRAWINGS

FIG. 1 is a block diagram of one embodiment of the present invention.

FIG. 2A is a flow chart illustrating the operation of one embodiment of the present invention.

FIG. 2B is a flow chart illustrating the end of a program according to one embodiment of the present invention.

FIG. 3 is a block diagram illustrating the ways to end the program.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

As used herein, the term “computer peripheral device” includes but is not limited to a computer input device or computer output device, such as a computer mouse, a track ball, a keyboard, a game controller, a wireless receiver, a card reader/writer, a web cam, and a microphone, among others.

The computer peripheral device 110 is illustrated herein as being embodied in the form of a computer mouse (which can be wired or wireless) which has an identification (ID) number issued by the manufacturer. The ID number can be selected from an internal production number, or a vendor number which is assigned by the protocol organization (such as USB protocol is assigned by the Institute of Electrical and Electronic Engineers (IEEE)). The computer peripheral device 110 of the present invention is provided with (i) a security mechanism that prevents unauthorized access to the computer 100, and (ii) a counting function that controls the amount of time that the computer 100 can be used by a user. Thus, the present invention operates under the principle that a user cannot access and use a computer 100 without an input device (such as a mouse or other similar peripheral device). In other words, by shutting down the input device that is associated with (or electronically “registered” to) a particular computer 100, the user would not be able to access and control the computer 100.

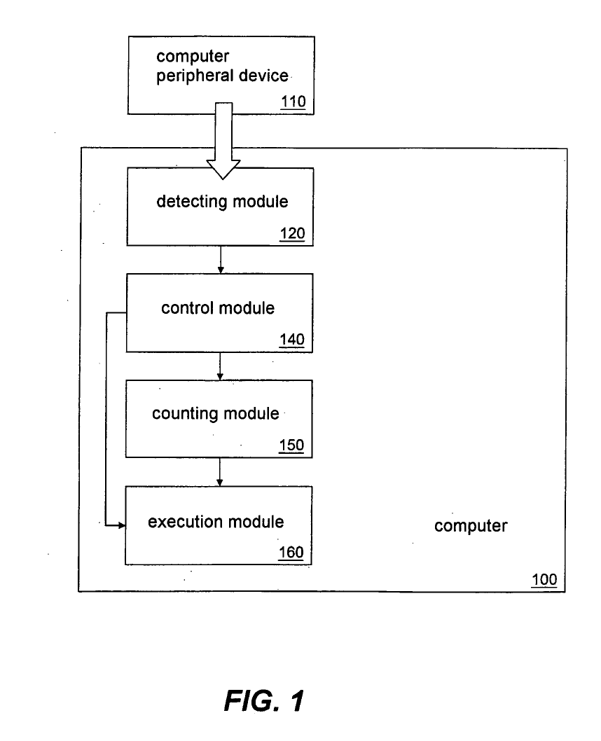

Referring to FIG. 1, the computer peripheral device 110 (hereinafter mouse 110) has an assigned ID number, and the computer 100 has a detecting module 120, a control module 140, a counting module 150 and an execution module 160. These modules are typically in a driver program that is stored at the CPU of the computer 100. The detecting module 120 detects the identity of the mouse 110 to determine if it has a correct or acceptable ID number. If the ID number is acceptable, the control module 140 will activate the counting module 150. If the ID number is incorrect, the control module 140 will activate the execution module 160 so as to shut down the computer 100 directly. The counting module 150 functions to count a remaining time for a permitted user before the execution module 160 takes over and shuts down the computer 100, which is referred to herein as a first predetermined time. During the first predetermined time (i.e., the time when the counting module 150 is counting), the user is permitted to continue using the computer 100.

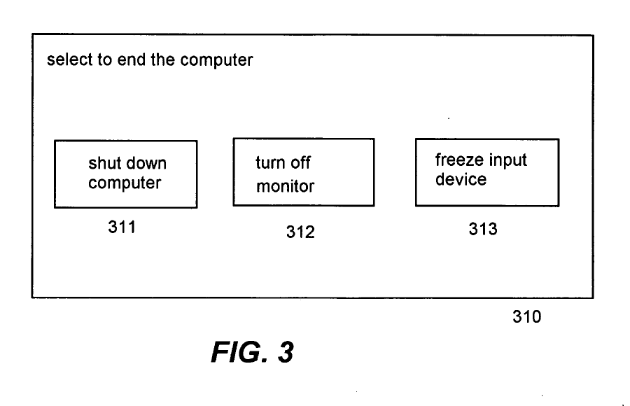

Referring to FIG. 3, once the first predetermined time has elapsed, the execution module 160 will ask the user to select one of three choices: (i) shut down the computer 311, (ii) turn off the monitor 312 or (iii) freeze the input device (keyboard or mouse) 313 such that the user will be forced to leave the computer 100 or take a rest for a second predetermined time (e.g., 30 minutes).

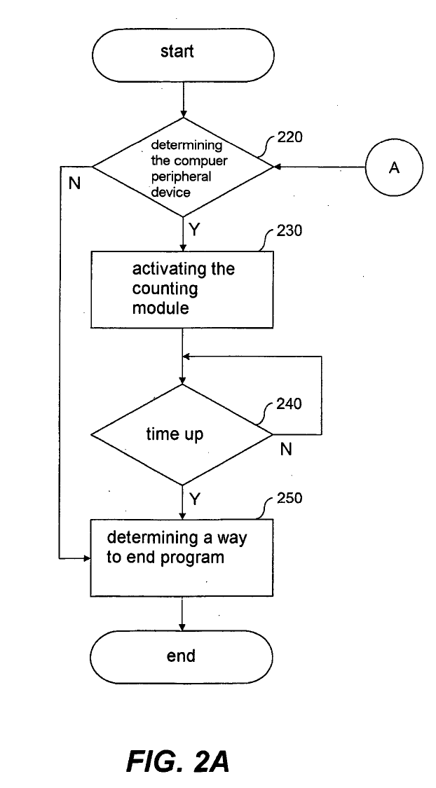

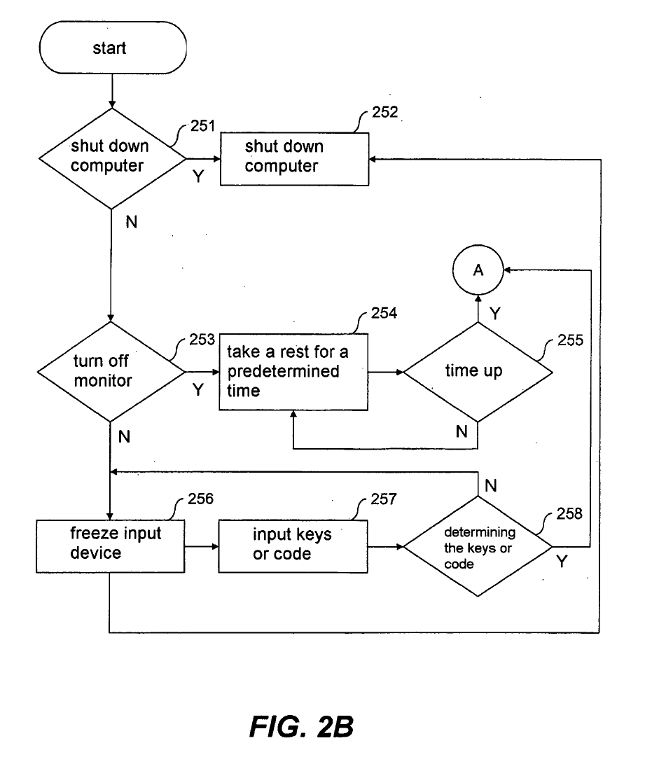

FIG. 2A illustrates a program flow chart according to one embodiment of the present invention. In step 220, the detecting module 120 detects the identity of the mouse 110 to see if it has a correct ID number. If the ID is correct, the control module 140 will activate the counting module 150 in step 230 to allow use of the computer for the first predetermined time. If the ID is incorrect, processing flows to step 250 where the control module 140 will activate the execution module 160 so as to shut down the computer 100 directly (see FIG. 3). From step 230, processing flows to step 240 where the counting module 150 will count a remaining time for a permitted user (the first predetermined time). Once the counting module 150 has finished counting the first predetermined time, processing proceeds to step 250 where the execution module 160 will ask the user to select a way (shown in FIG. 3) to end the program.

Referring to FIG. 2B, in step 251, if the user selects to shut down the computer 100, then the computer 100 will be turned off directly in step 252. Otherwise, processing flows to step 253, where the user decides whether to turn off the monitor. If the user decides to turn off the monitor in step 253, then the counting module 150 will count down for the second predetermined time (e.g., 30 minutes) in step 254. This second predetermined time is actually a “rest” time, or the time when the user is denied access to the computer 100. Step 255 determines whether the count down procedure has been finished (i.e., whether the second predetermined time has elapsed). If no, then processing returns to step 254. If the counting of the second predetermined time has been completed, processing proceeds to Step A in FIG. 2A where the detecting module 120 again detects the identity of the mouse 110 to see if it has a correct ID number. If the ID of the mouse 110 is correct, then the user can operate the computer again (as shown in FIG. 2A) for the first predetermined time. Thus, steps 230 and 240 limit the use of the computer to a predetermined time, so that children can be limited to the use of the computer only for a predetermined amount of time.

If the user decides not to turn off the monitor in step 253, then processing proceeds to step 256, where the input device (e.g., mouse 110) is shut down to prevent further access to the computer 100. In step 257, an administrator (e.g. a parent) may input a combination key or code to obtain access to the computer. Step 258 determines whether the key or code inputted in step 257 matches the pre-programmed key or code. If the key or code matches, then processing returns to step A in FIG. 2A where the detecting module 120 again detects the identity of the mouse 110 to see if it has a correct ID number. If the ID of the mouse 110 is correct, then the user can operate the computer again (as shown in FIG. 2A) for the first predetermined time. On the other hand, if the key or code is incorrect, access to the computer 100 is denied.

Thus, the present invention provides a security mechanism so that an unauthorized person still cannot access the computer unless he or she uses the original mouse, even if this person breaks the code set in the BIOS or other security mechanism. If this unauthorized person instead connects a different mouse to the computer, the computer will shut down directly because the computer detected a mouse with an incorrect ID number.

In addition, if the user wishes to limit the computer time for his or her children, the user can set the first predetermined time in the manner described above so as to force the children to take a rest for the second predetermined time after regular time intervals. If the user takes away the input device, the child cannot use the computer even if the child attempts to connect a new input device to the computer.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method for controlling access to a computer, comprising:
providing a peripheral device with an identification number;
coupling the peripheral device to a computer;
verifying the accuracy of the identification number of the coupled peripheral device;
preventing operation of the computer if the identification number is not correct; and
counting a first predetermined time for operation of the computer if the identification number is correct, and then preventing operation of the computer after the first predetermined time has elapsed.

2. The method of claim 1, wherein preventing operation of the computer is selected from the group consisting of: shutting down the computer, turning off a monitor that is coupled to the computer, and shutting down the peripheral device.

3. The method of claim 1, further including the step of providing the peripheral device from the group consisting of: a mouse, a trackball, a keyboard, a game controller, a wireless receiver, a card reader, and a web cam.

4. A method for controlling access to a computer, comprising:
a. providing a peripheral device with an identification number;
b. coupling the peripheral device to a computer;
c. verifying the accuracy of the identification number of the coupled peripheral device;
d. preventing operation of the computer if the identification number is not correct; and
e. if the identification number is correct:
e1. counting a first predetermined time for operation of the computer;
e2. preventing operation of the computer after the first predetermined time has elapsed;
e3. counting a second predetermined time during which operation of the computer is prevented; and
e4. returning to step (c).

5. The method of claim 4, wherein preventing operation of the computer comprises the step of turning off a monitor that is coupled to the computer.

6. The method of claim 4, further including the step of providing the peripheral device from the group consisting of: a mouse, a trackball, a keyboard, a game controller, a wireless receiver, a card reader, and a web cam.

7. A system comprising:
a computer peripheral device having a computer security mechanism that includes an identification number; and
a computer that is coupled to the peripheral device and includes a detecting module, a control module, and an execution module; and
wherein the detecting module verifies the accuracy of the identification number, and the control module enables the execution module to end the operation of the computer when the identification number is not acceptable to the computer.

8. The system of claim 7, wherein the computer further includes a counting module that counts a predetermined time when the identification number is acceptable to the computer.
